(19) United States
(12) Patent Application Publication
(10) Pub. No.: US 2013/0208505 A1
(43) Pub. Date: Aug. 15, 2013

(54) Backlight Module

(71) Applicant: Gang Yu, Shenzhen (CN)

(72) Inventor: Gang Yu, Shenzhen (CN)

(73) Assignee: Shenzhen China Star Optoelectronics Technology Co. LTD., Shenzhen City ,Guangdong (CN)

(21) Appl. No.: 13/508,728

(22) PCT Filed: Mar. 16, 2012
(86) PCT No.: PCT/CN2012/072458

§ 371 Date: May 8, 2012

(30) Foreign Application Priority Data
Feb. 15, 2012 (CN) 201210034009.5

(51) Int. Cl. F21V 7/04

(52) U.S. Cl. 362/609

(57) ABSTRACT

A backlight module includes a backboard, a light guide board arranged inside the backboard, and a side reflection plate arranged inside the backboard. The backboard includes a bottom plate and a plurality of side plates connected to the bottom plate. The light guide board includes a bottom surface facing the bottom plate, a top surface distant from the bottom plate, and a plurality of side surfaces connecting between the bottom surface and the top surface. The plurality of side surfaces comprises a plurality of passive light exit surfaces. The side reflection plate is made of an elastic material. The side reflection plate is positioned against both one of the passive light exit surfaces of the light guide board and one of the side plates of the backboard that opposes said one of the passive light exit surfaces.

### BACKGROUND OF THE INVENTION

1. Field of the Invention

The present invention relates to the technical field of liquid crystal displaying, and in particular to a backlight module.

2. The Related Arts

Liquid crystal display (LCD) has a variety of advantages, such as compact device size, low power consumption, and being free of radiation, and is thus widely used. Most of the LCDs that are currently available in the market are backlighting LCDs, which comprise a liquid crystal panel and a backlight module. The working principle of the liquid crystal panel is that liquid crystal molecules are interposed between two parallel glass plates and a plurality of vertical and horizontal fine electrical wires is arranged between the two glass plates, whereby the liquid crystal molecules are controlled to change direction by application of electricity to refract light emitting from the backlight module for generating images. Since the liquid crystal panel itself does not emit light, light must be provided by the backlight module in order to generate images. Thus, the backlight module is one of the key components of an LCD. The backlight module can be classified as two types, namely side-edge backlight module and direct backlight module, according to the position where light gets incident. The direct backlight module arranges a light source, such as a cold cathode fluorescent lamp (CCFL) or a light-emitting diode (LED) at the back side of the liquid crystal panel to form a planar light source to directly provide lighting to the liquid crystal panel. The side-edge backlight module arranged an LED light bar of light source at an edge of a backboard that is located rearward of one side of the liquid crystal panel. The LED light bar emits light that enters a light guide plate through a light incident face of the light guide plate and is projected out through a light exit face after being reflected and diffused to thereby form a planar light source to be provided to the liquid crystal panel.

As shown in FIG. 1, a conventional side-edge backlight module generally comprises: a backboard 100, a bottom reflection plate 200 mounted on the backboard, a light guide board 300 positioned on the bottom reflection plate 200, an optic film 400 arranged on the light guide board 300, a backlight source (not shown) arranged inside the backboard 100, and a plastic frame 500 coupled to the backboard 100. The backboard 100 comprises a bottom plate 101 and a side plate 102 connected to the bottom plate 101. The light guide board 300 comprises a bottom surface 301 facing the bottom plate 101, a top surface 302 distant from the bottom plate 101, and a plurality of side surfaces 303 connecting between the bottom surface 301 and the top surface 302. In the configuration of the side-edge backlight module, one or two of the side surfaces 303 of the light guide board 300 are arranged to face the backlight source to serve as light incidence surfaces 303, while the remaining side surfaces serve as passive light exit surfaces 303, to which side reflection plates 600 are bonded by means of double-sided adhesive tapes in order to prevent light from emitting through the passive light exit surfaces 303 for the purposes of avoiding lowering of luminance of the backlight module. However, the presence of the double-sided adhesive tapes alters the surface configuration of the side reflection plates 600, so that diffuse reflection occurs when light transmits through the side reflection plates 600, making a portion of the light directly project out through the passive light exit surfaces 303 of the light guide board 300. This, on the one hand, reduces the luminance of the backlight module, and on the other hand, causes bright lines on side frame of the backlight module.

### SUMMARY OF THE INVENTION

An objective of the present invention is to provide a backlight module, which realizes uniform luminance, elimination of bright line, enhancement of luminance of backlight module, and simple structure and low cost by tightly positioning a side reflection plate that is of elasticity against a light guide board.

To achieve the objective, the present invention provides a backlight module, which comprises: a backboard, a light guide board arranged inside the backboard, and a side reflection plate arranged inside the backboard. The backboard comprises a bottom plate and a plurality of side plates connected to the bottom plate. The light guide board comprises a bottom surface facing the bottom plate, a top surface distant from the bottom plate, and a plurality of side surfaces connecting between the bottom surface and the top surface. The plurality of side surfaces comprises a plurality of passive light exit surfaces. The side reflection plate is made of an elastic material. The side reflection plate is positioned against both one of the passive light exit surfaces of the light guide board and one of the side plates of the backboard that opposes said one of the passive light exit surfaces.

The side reflection plate comprises a main body and a reflection layer formed on the main body. The main body is positioned against said one of the side plates of the backboard. The reflection layer is positioned against said one of the passive light exit surfaces of the light guide board.

The reflection layer comprises a reflection film attached to the main body.

The reflection layer comprises a material of high reflectivity coated on the main body.

The main body is made of an elastic material.

The elastic material comprises a rubber material.

The elastic material comprises a white material.

The efficacy of the present invention is that the present invention provides a backlight module that comprises a side reflection plate that is tightly positioned against a passive light exit surface of a light guide board so as to eliminate the use of double-sided adhesive tape and thus overcome the issue of diffuse reflection caused by the side reflection plate due to the presence of the double-sided adhesive tape found in the known techniques. Further, due to the elasticity of the side reflection plate, the side reflection plate is constantly kept in tight engagement with the light guide board so as to eliminate leakage of light, to ensure desired luminance of the backlight module, and to realize simplified structure and lowered cost.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as beneficial advantages, will be apparent from the following detailed description of embodiments of the present invention, with reference to the attached drawings. In the drawings:

FIG. 1 is a cross-sectional view showing a conventional backlight module;

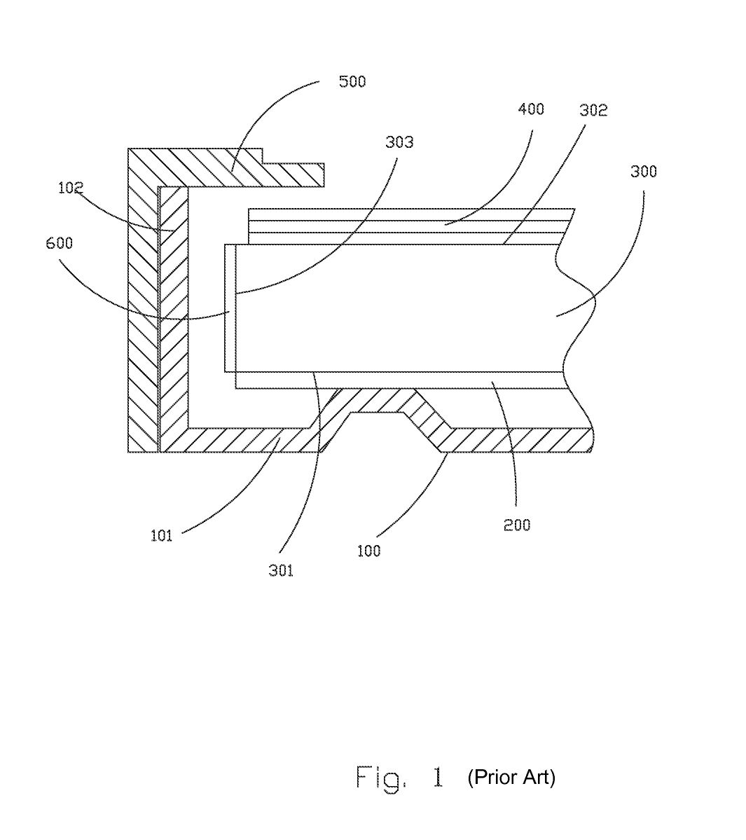

FIG. 2 is a cross-sectional view showing a backlight module according to an embodiment of the present invention; and

FIG. 3 is a cross-sectional view showing a backlight module according to another embodiment of the present invention.

### DETAILED DESCRIPTION OF THE PREFERRED EMBODIMENTS

To further expound the technical solution adopted in the present invention and the advantages thereof, a detailed description is given to preferred embodiments of the present invention and the attached drawings.

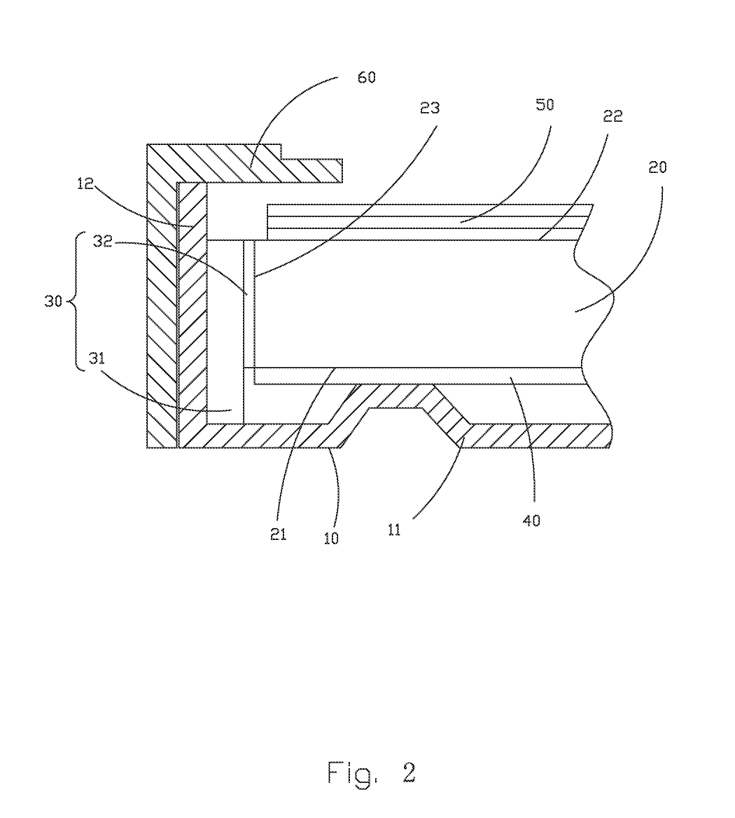

With reference to FIG. 2, a view is given to show a backlight module according to an embodiment of the present invention. The backlight module comprises: a backboard 10, a light guide board 20 arranged inside the backboard 10, and a side reflection plate 30 arranged inside the backboard 10.

The backboard 10 comprises a bottom plate 11 and a plurality of side plates 12 connected to the bottom plate 11. The light guide board 20 is mounted on the bottom plate 11 of the backboard 10. The side reflection plate 30 is mounted to the side plate 12 of the backboard 10.

The light guide board 20 comprises a bottom surface 21 facing the bottom plate 11, a top surface 22 distant from the bottom plate 11, and a plurality of side surfaces connecting between the bottom surface 21 and the top surface 22. The plurality of side surfaces comprises a plurality of light incidence surfaces (not shown) and a plurality of passive light exit surfaces 23.

The side reflection plate 30 is made of an elastic material. The side reflection plate 30 is positioned against both one of the passive light exit surfaces 23 of the light guide board 20 and one of the side plates 12 of the backboard 10 that opposes said one of the passive light exit surfaces 23.

The side reflection plate 30 comprises a main body 31 and a reflection layer 32 formed on the main body 31. The main body 31 is positioned against the side plate 11 of the backboard 10 and the reflection layer 32 is positioned against said one of the passive light exit surfaces 23 of the light guide board 20. The main body 31 is made of an elastic material and, in the instant embodiment, the elastic material is a rubber material. The reflection layer 32 can be a reflection film attached to the main body and such a reflection film can be a known one. The reflection layer 32 can alternatively be a material of high reflectivity coated on the main body 31. Due to the elasticity of the main body 31, the reflection layer 32 is set in tight engagement with said one of the passive light exit surfaces 23 of the light guide board 20. When the light guide board 20 is heated and expands, the main body 31 undergoes elastic deformation with the expansion, providing excellent cushioning that protects the light guide board 20 against deformation or break caused by being compressed. When the light guide board 20 restores from the expansion, the elastic deformation of the main body 31 is also released, allowing the reflection layer 32 to constantly keep in tight engagement with the passive light exit surface 23 of the light guide board 20. The reflection film 32 may realize excellent reflection of light, eliminating the use of double-sided adhesive tape and thus eliminating the occurrence of diffuse reflection found in the known techniques and thus bright lines. Preferably, all the passive light exit surfaces 23 of the light guide board 20 are respectively provided with side reflection plates 30, to provide the desired luminance of the whole backlight module.

The backlight module may further comprise a bottom reflection plate 40 that disposed on the bottom plate 11 of the backboard 10 and positioned against the bottom surface 21 of the light guide board 20, an optic film 50 that is arranged on the top surface 22 of the light guide board 20, a plastic frame 60 mounted to the backboard 10, and a backlight source (not shown) arranged on the backboard 10.

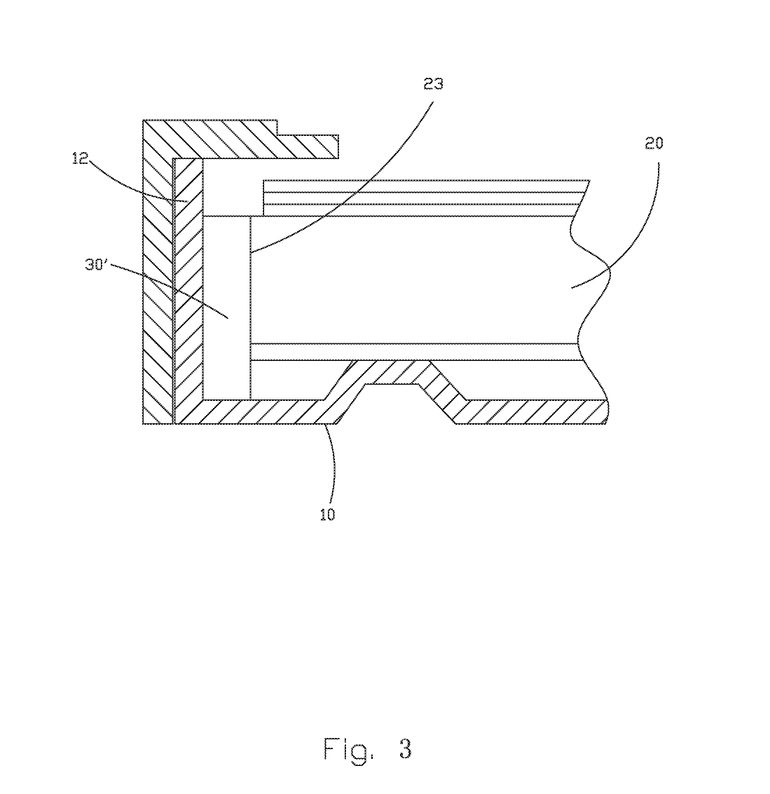

Referring to FIG. 3, a cross-sectional view is given to show a backlight module according to another embodiment of the present invention. In the instant embodiment, the side reflection plate 30′ is simultaneously positioned against the passive light exit surface 23 of the light guide board 20 and one of the side plates 12 of the backboard 10 that opposes the passive light exit surface 23. The side reflection plate 30′ is made of a white elastic material. The white elastic material can be white rubber material. Thus, no reflection film is needed, neither a coating of high reflectivity material. Light can be directly reflected by the white surface of the side reflection plate 30′ that is positioned on the passive light exit surfaces 23 of the light guide board 20, and the same technique advantage as that of the previous embodiment can be obtained.

The side reflection plate according to the present invention is applicable to both side-edge backlight module and direct backlight module.

In summary, the present invention provides a backlight module that comprises a side reflection plate that is tightly positioned against a passive light exit surface of a light guide board so as to eliminate the use of double-sided adhesive tape and thus overcome the issue of diffuse reflection caused by the side reflection plate due to the presence of the double-sided adhesive tape found in the known techniques. Further, due to the elasticity of the side reflection plate, the side reflection plate is constantly kept in tight engagement with the light guide board so as to eliminate leakage of light, to ensure desired luminance of the backlight module, and to realize simplified structure and lowered cost.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A backlight module, comprising: a backboard, a light guide board arranged inside the backboard, and a side reflection plate arranged inside the backboard, the backboard comprising a bottom plate and a plurality of side plates connected to the bottom plate, the light guide board comprising a bottom surface facing the bottom plate, a top surface distant from the bottom plate, and a plurality of side surfaces connecting between the bottom surface and the top surface, the plurality of side surfaces comprising a plurality of passive light exit surfaces, the side reflection plate being made of an elastic material, the side reflection plate being positioned against both one of the passive light exit surfaces of the light guide board and one of the side plates of the backboard that opposes said one of the passive light exit surfaces.

2. The backlight module as claimed in claim 1, wherein the side reflection plate comprises a main body and a reflection layer formed on the main body, the main body being positioned against said one of the side plates of the backboard, the reflection layer being positioned against said one of the passive light exit surfaces of the light guide board.

3. The backlight module as claimed in claim 2, wherein the reflection layer comprises a reflection film attached to the main body.

4. The backlight module as claimed in claim 2, wherein the reflection layer comprises a material of high reflectivity coated on the main body.

5. The backlight module as claimed in claim 2, wherein the main body is made of an elastic material.

6. The backlight module as claimed in claim 1, wherein the elastic material comprises a rubber material.

7. The backlight module as claimed in claim 1, wherein the elastic material comprises a white material.
